(19) United States
(12) Patent Application Publication
(10) Pub. No.: US 2008/0295164 A1
(43) Pub. Date: Nov. 27, 2008

(54) MASHUP COMPONENT ISOLATION VIA SERVER-SIDE ANALYSIS AND INSTRUMENTATION

(75) Inventors: Michael Steiner, New York, NY (US); Krishnaprasad Vikram, Ithaca, NY (US)

Correspondence Address: SCULLY, SCOTT, MURPHY & PRESSER, P.C., 400 GARDEN CITY PLAZA, SUITE 300, GARDEN CITY, NY, 11530, US

(73) Assignee: INTERNATIONAL BUSINESS MACHINES CORPORATION, Armonk, NY (US)

(21) Appl. No.: 11/753,223

(22) Filed: May 24, 2007

(51) Int. Cl. G06F 9/00

(52) U.S. Cl. 726/14

(57) ABSTRACT

A method, system, and computer program storage device are disclosed for providing security in a mashup comprised of an agglomeration of a plurality of portlets. These portlets are sent from one or more back-end servers, pass through a portal server, and are received by a client browser. The method comprises the steps of developing an isolation boundary between the portlets to isolate each of the portlets from each of the other portlets, and extending said isolation boundary through the portal server and through the browser. Preferably, the portal server bases the isolation boundary on a server-side static analysis and code instrumentation of the portlets. In the preferred embodiment of the invention, each of the portlets is checked for a number of syntactic constraints and marked with a corresponding service domain. The portlets are aggregated into a page-using HTML, and that page is converted into JavaScript.

### BACKGROUND OF THE INVENTION

1. Field of the Invention

The present invention generally relates to computer network security, and more specifically, to implementing security features at a portal server.

2. Background Art

A portal site is a World Wide Web site or service that offers a broad array of resources and services, such as e-mail, forums, search engines, and on-line shopping malls. A portal server functions as a Web server that hosts the portal site. Prior art portal sites usually categorize content and provide a hyperlink for each category. The hyperlinks may lead to other Internet Web sites outside the portal server. Users access the portal server via a Web browser and click on a hyperlink to read content. Examples of such portal servers are those run by Yahoo!, Microsoft Network, and America Online.

Some portal servers provide access to a plurality of software applications, where the software applications are stored in servers that are external to the portal server. Such software applications are called backend applications, and the servers in which the backend applications are stored are called backend systems. A user directs a Web browser to connect to the portal server, and subsequently accesses the backend applications via the portal server. The portal servers provide a single point of interaction to the backend applications personalized to the user's needs and responsibilities. A single unified interface on a portal server typically provides the single point of interaction to a user.

Portal servers can transform the manner in which users access, manage, and share essential data and applications. Portal servers may organize business applications, syndicated content, e-mail messages, and any other relevant information into a workspace that can be customized to a user's specifications. An example of such a portal server is the Netegrity** Interaction Server.

When a portal server provides access to backend applications users do not have to store bookmarks at a Web browser for each of the individual backend applications. For example, corporate users may use a Web browser and access corporate-wide applications, such as Web-based electronic mail, instant messaging system, corporate accounting information etc., via a corporate portal server.

Most portals and portal frameworks contain the concept of a “portlet.” A portlet is a window to a specific set of content within the overall context of the portal page. Many portlets support the ability to customize the information displayed within this window. From the perspective of the portal framework or platform, portlets tend to look and behave much the same as individual windows running in a MICROSOFT WINDOWS™-based operating system. Portlets may be minimized, maximized, and re-arranged around the display screen to suit the taste of the individual portal user.

From the developer's perspective, a portlet is simply a piece of code that plugs into a generalized framework. Different portal frameworks implement the concept of a portlet differently. In some cases, the portlet is a collection of SUN MICROSYSTEM'S JAVA™ SERVER PAGES™ (JSP) pages. In other cases, it may be a special type of class that implements certain interfaces. Regardless of how it is implemented, the portlet is generally responsible for presenting a specific set of content that may be tailored to a user's preferences. The portal framework is responsible for handling the infrastructure services, such as providing the overall presentation, user management, security, and personalization.

One common use of portal servers is to aggregate information from multiple backend servers onto a single user screen, a procedure referred to as mashup, and a number of applications, including Web 2.0, are enabled to do this.

Web 2.0 mashups provide exciting new ways to aggregate information services from multiple providers, and present them to users. However, given that these services stem from different and not necessarily mutually trusting providers, it is clear that such mashups should be built on a sound security foundation protecting the interests of the various involved parties, such as the providers and the end-user. For example, in a mashup providing a one-stop car purchase portal combining information from different dealers and the user's bank, neither should dealers be able to modify each other's car prices nor should they be able to spy on a user's bank account.

Unfortunately, mechanisms offered by current browsers are rather weak and lack clean ways to isolate different client-side components, as well as limit their interaction to tightly control-label channels. In particular, the same-original policy turns out to be deficient: On the other hand, it is too restrictive as it prevents safe communication between different sites which often results in developers using dynamically inserted <script> tags, e.g., JSONP, which give the remote side arbitrary control over the page content. On the other hand, the policy is too weak as it provides no separation between components from the same site, even though such information might stem from server-side aggregation combining sources of different trustworthiness such as is seen often in Internet portals and advertisement-sponsored web-pages. Even for a situation such as enterprise portals where arguably information comes from the same trust domain and, potentially, providers are co-residing on the same (portal or backend) server, the sensitivity of salary data and alike makes security-in-the-depth and proper provider isolation a necessity to protect against programming errors such as cross-site-scripting attacks.

While secure solutions could be built in principle, the involved subtleties are quite complex. What is needed are new high-level and fail-safe programming features and corresponding isolation mechanisms for securely separating components of a mush-up.

### SUMMARY OF THE INVENTION

An object of this invention is to improve security for mashups.

Another object of the present invention is to separate securely the different components of a mash-up.

A further object of the invention is to use server-side analysis and instrumentation to isolate portlets from each other, where those portlets are used to aggregate services from multiple providers.

These and other objectives are attained with a method and system for providing security in a mashup comprised of an agglomeration of a plurality of portlets, wherein said portlets are sent from one or more back-end servers, pass through a portal server, and are received by a client browser. The method comprises the steps of developing an isolation boundary between the portlets to isolate each of the portlets from each of the other portlets, and extending said isolation boundary through the portal server and through the client browser. Preferably, the portal server bases the isolation boundary on a server-side static analysis and code instrumentation of the portlets.

In the preferred embodiment of the invention, the developing step includes the steps of, for each of the portlets, checking a number of syntactic constraints; marking said each of the portlets with a corresponding service domain, aggregating the portlets into a page using a first given language, such as HTML and after the aggregating step, converting the page into a second language, such as JavaScript. On the Javascript output, the developing steps subsequently include steps of static analysis to ensure invariants which maintain isolation and code instrumentation to ensure that some isolation invariants, which cannot be proven statically, are enforced at runtime. Also, in this preferred embodiment, the portal server does all the checking marking aggregating and converting steps.

Further benefits and advantages of the invention will become apparent from a consideration of the following detailed description, given with reference to the accompanying drawing, which specifies and shows preferred embodiments of the invention.

### BRIEF DESCRIPTION OF THE DRAWINGS

FIG. 1 illustrates a block diagram of a computer network environment in which the present invention may be implemented.

FIG. 2 illustrates the use of portlets with a portal server and a pair of browsers.

FIG. 3 shows the current state of security in the environment of FIG. 2.

FIG. 4 generally depicts portlet isolation in accordance with the present invention.

FIG. 5 shows a DOM interface.

FIG. 6 shows a security solution scheme according to this invention.

FIG. 7 illustrates an information flow lattice.

FIG. 8 is a diagram of an exemplary computing system that may be used in the practice of this invention.

### DETAILED DESCRIPTION OF THE PREFERRED EMBODIMENTS

In the following description, reference is made to the accompanying drawings which form a part hereof and which illustrate several implementations. It is understood that other implementations may be utilized and structural and operational changes may be made without departing from the scope of the present implementations.

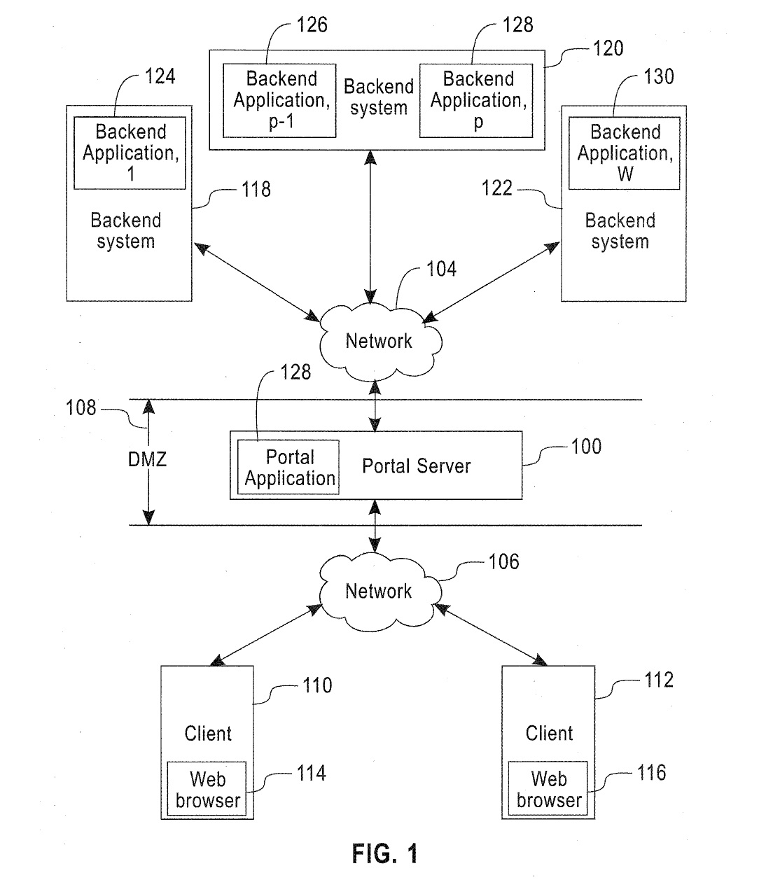

FIG. 1 illustrates a block diagram of a computing environment including certain implementations of the invention. A portal server 100 contains a portal application 102 and connects to two networks 104 and 106. The portal server 100 may be any computational device such as a personal computer, a workstation, a server-class computer, a mainframe, a laptop, hand-held, palm-top or telephony device. Network 104 and 106 may be a local area network, an Intranet, the Internet or any other type of network. In one implementation network 104 is a local area network and network 106 is the Internet.

Portal server 100 is located within a demilitarized zone (DMZ) 108. The DMZ 108 allows the portal server 100 to host Internet services but at the same time prevents unauthorized access to the network 104 via Internet connections to the portal server 100. Computational devices that connect to network 106 cannot connect to computational devices that connect to network 104 except via the portal server 100. The DMZ 108 insulates network 104 and 106 from each other and thereby provides some network security. The DMZ 108 is created by insulating the portal server 100 via firewalls, proxy servers etc. from networks 104, 106 in a manner known in the art.

The portal application 102 is a Web based application. Clients 110 and 112 can connect to the portal application 102 on the portal server 100 through the network 106 via the hypertext transfer protocol (HTTP) from Web browsers 114, 116. For example, Web browser 114 may send a HTTP request for the portal application 102 from client 110 to portal server 100 across network 106. In response to the HTTP request from the client 110, the portal application 102 sends a Web page to the client 110. The Web browser 114 on the client 110 displays the Web page. The portal application may be implemented in any programming language such as Java**, C++ etc. The Web pages sent by the portal server 100 to the clients 110 and 112 may include code in Active server pages**, Java server pages, Hypertext Markup languages (HTML), Extensible Markup Language (XML) etc. The Web browsers 114, 116 render the code on the screen of the clients 110, 112.

Backend systems 118, 120, 122 connect to portal server 100 via the network 104. Each of the backend systems 118, 120, 122 contains one or more backend application [1 . . . w] 124, 126, 128, 130. In FIG. 1, backend system 118, contains one backend application 124; backend system 120 contains two backend applications 126, 128; and backend system 122 contains one backend application 130. The backend systems 118, 120, 122 may be any computational device such as a personal computer, a workstation, a server-class computer, a mainframe, a laptop, hand-held, palm-top or telephony device. The backend applications 124, 126, 128, 130 may be any server-based software application such as Web-based electronic mail, an Instant messenger server, a server-based spreadsheet, a database server etc.

The portal application 102 provides a single point of access to the [1 . . . w] backend applications 124, 126, 128, 130. Clients 110, 112 access the [1 . . . w] backend applications 124, 126, 128, 130 by accessing the portal application 102.

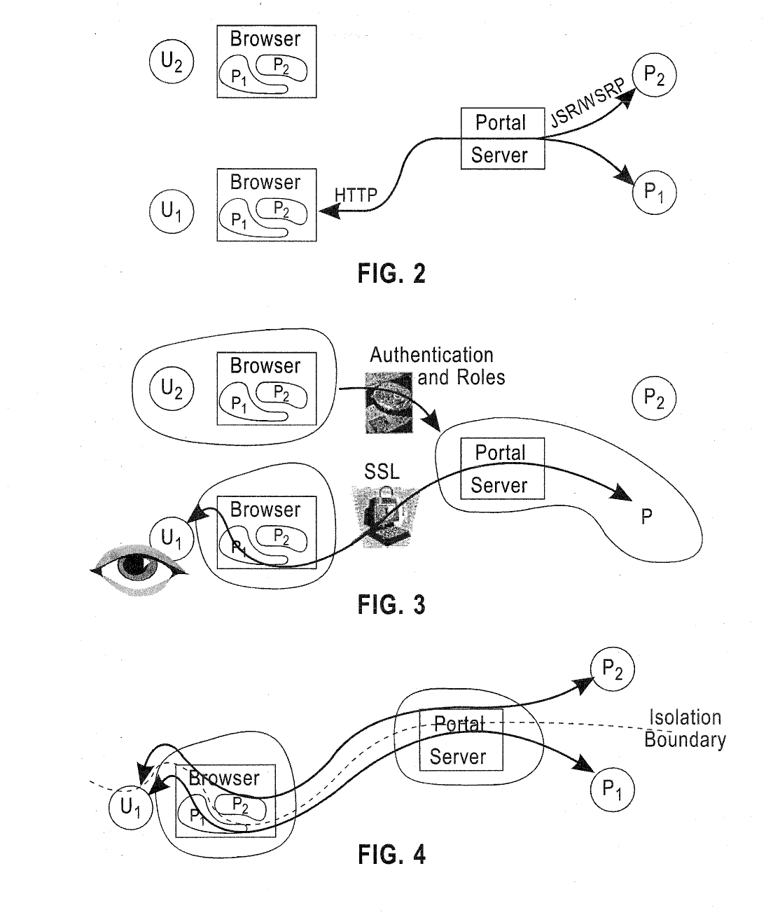

With reference to FIGS. 1 and 2, portal 100 may contain various and multiple portlets 202, 204, which are pieces of code that plug into a generalized framework. The portlets are sent from the backend applications, pass through the portal server 100, and are sent to the client computers 110, 112, specifically, the web browsers 114, 116 thereof.

As mentioned above, mashups should be built on a sound security foundation, protecting the interests of the various involved parties such as the providers and the end-users. Unfortunately, mechanisms offered by current browsers are rather weak and lack clean ways to isolate different client side components as well as limit their interaction to tightly controllable channels. For instance, FIG. 3 illustrates the current state of security. As shown, security protection, represented at 206, may be provided between a portal server and a browser; and, as represented at 210, a particular user may require authentication and be limited to one or more roles in their interaction with a portal server. This security protection, however, does not isolate the portlets from each other.

The present invention addresses this issue. Generally, as illustrated in FIG. 4, this is done by establishing an isolation boundary 310 between portlets 202 and 204. This isolation boundary extends through the portal server 100 and the browser 114, keeping portlets 202 and 204 separate from each other.

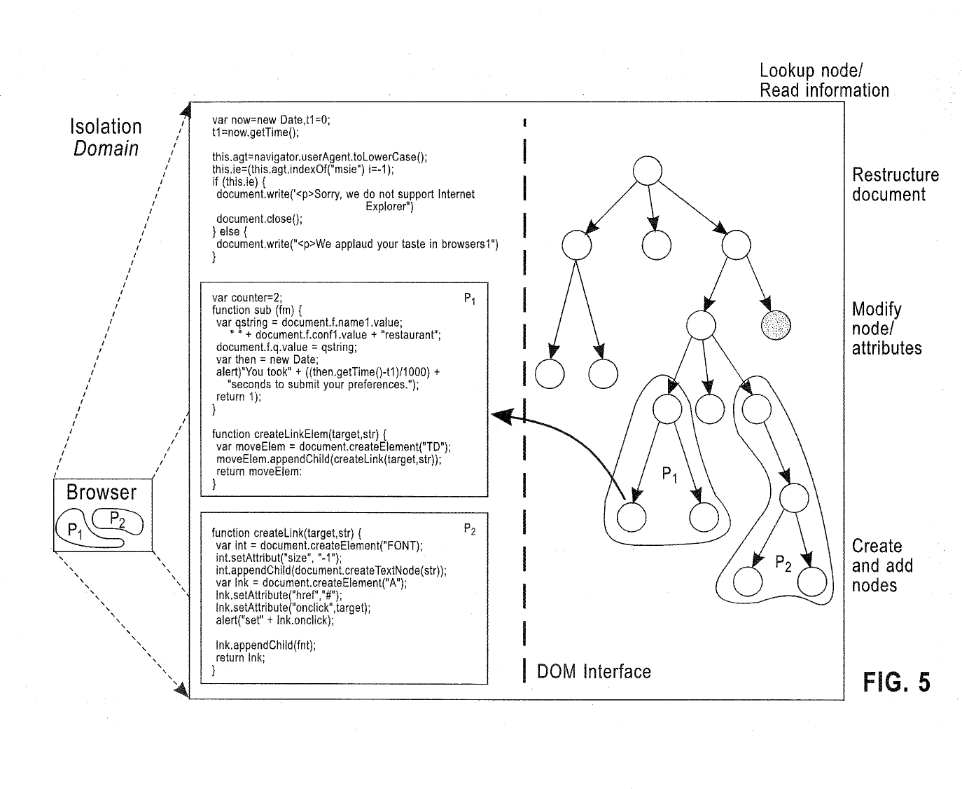

In accordance with the preferred embodiment of this invention, the foundation for component separation is based on server-side static analysis and code instrumentation. The security model enforced by this invention is isolation of portlets from each other. More specifically, portlets and their associated JavaScript code are contained to disjoint well-identified DOM subtrees. FIG. 5 illustrates a DOM Interface 320.

JavaScript poses a number of new challenges due to its dynamic nature, which allows to modify virtually any code and to evaluate—using a multitude of ways—arbitrary code and runtime. Furthermore, to address the browser environment one also has to incorporate the Document Object Model (DOM), which in turn also adds additional ways for self-modification of code and data. This makes it hard to analyze arbitrary code and to make interposition code tamper proof.

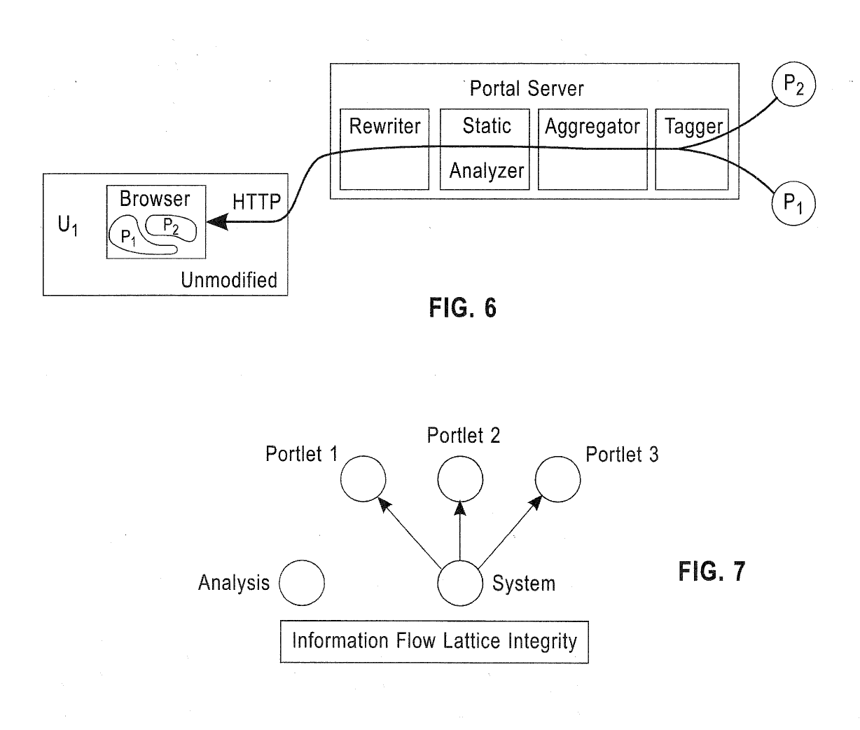

With reference to FIG. 6, the preferred approach of the present invention, generally, comprises the following steps: (1) For each portlet fragment, a number of syntactic constraints are checked, and each fragment is marked with its corresponding security domain by wrapping it in a special div element portlet-root; (2) After aggregation of the portlet fragments into a whole HTML page, the page is converted into an equivalent JavaScript program, i.e., one which renders the exact same content; (3) Together with an object model of the browser's DOM, also defined in JavaScript, a static analysis of isolation and integrity constraints using, for example, IBM Research's WALA (http://wala.sourceforge.net/) libraries; and (4) Finally, certain code constructs are rewritten, e.g., to separate name spaces. Any failure of previously mentioned checks results in a rejection of the portlet page as unsafe.

Converting everything into JavaScript allows for a unified analysis approach. For instance, having converted the HTML into equivalent JavaScript, the analysis engine automatically constructs an object model for the DOM tree for the page, which is used to perform precise alias analysis of DOM objects. Uniformly, using JavaScript also enables easy customizations to particular browsers, which are usually not 100% standards-conformant and provide various security-sensitive extensions.

The tagger 340 checks syntactic constraints in HTML, e.g., that the HTML fragment consists of a well-formed, contains only elements valid inside a HTML <body> element and “src” attributes of selected elements are limited to well-known and approved locations consistent with the actual HTML element instance. The tagger also checks syntactic correctness of JavaScript. Also, the Tagger wraps up the portlet markup within a DIV element, call it root (domain), to mark domain boundaries and normalizes and sanitizes the HTML representation, e.g., by removing comments, removes the source of ambiguity in browser implementations. The aggregator 342 aggregates the portlets into a whole HTML page.

The Analyzer 344 transforms the aggregated HTML page into an equivalent JavaScript program The Analyzer contains a model of the browser runtime environment, e.g., Javascript host objects and library code, as a Javascript program marked with its own domain. The Analyzer, in the preferred embodiment, uses the IBM CAPA/DOMO framework for static analysis, and produces a call graph, with SSA instructions, representing the combination of the transformed aggregated HTML page and the model of the runtime. Also, the Analyzer 344 restricts Tree-Walking, maintains HTML consistency variants, and maintains integrity of data/code. Rewriter 346 then rewrites certain code constraints, for instance to separate name spaces.

Four examples of constraints that are preferably performed in step (3) are maintenance of the invariants on the DOM tree, the restriction of DOM tree walking of a portlet to its domain, the prevention of unknown code injection at runtime and the protection of integrity of system code.

To maintain the invariants of the DOM tree, initially verified by the tagger in Paragraph [0039] the analyzer establishes, e.g., that inserted DOM elements are untampered DOM elements created by the corresponding system libraries. It also verifies that the type of the element is an element legal inside an HTML <body> element but not a <script> element.

To restrict tree walking, we perform a pointer analysis on all operations that climb up the tree—descending is always safe—and make sure that the points-to set does not include the portlet-root element. Together with the constraints guaranteed by constructions in step (1), the name space separation ensured by step (4), this will guarantee the invariant that a portlet can only access its own DOM elements.

To prevent insertion of unknown code at runtime, the analyzer, e.g., makes sure that calls to eval, setTimer, setInterval and Function( ) occur only with (string) parameters which can be statically determined and that no code calls the write function or innerHTML attribute on DOM nodes. Additionally, the analyzer checks that no URL on DOM element or CSS elements directly executes javascript using the “url:” or “javascript:” constructions. Furthermore, as mentioned above, the analyzer verifies that the element will not load new Javascript code by ensuring that no <script> element is loaded.

The above algorithm relies also on the integrity of the systems libraries, which brings us to the last example of analysis. To maintain code integrity, we have to assure that no user code can redefine system code or objects. Furthermore, we have to make sure that system functions only receive objects as parameters, which meet the expectation, i.e., the parameter to the method appendChild of DOMNode must be a proper DOMNode generated by DOMDocument.createElement or equivalent. This is necessary to prevent a rogue element to subvert the browser “inside-out”. To achieve this, an information-flow lattice, for example, represented at 360 in FIG. 7, has to be enforced to prevent user information from flowing into system code. Given the multiple ways JavaScript allows to alias functions and variables, care should be taken to do appropriate alias analysis.

The Rewriter 346 ensures that Javascript namespaces (global variables, functions and property names of well-known types) of the portlet does not collide with other domains by remapping corresponding names to unpredictable names unless they are contained explicitly in the set of approved system functionality. This is performed by rewriting names and appending a domain specific identifier as well as instrumenting the accessor and setter function to appropriately prepond and removes, respectively, this domain identifier. Similarly, the Rewriter ensures that the namespace of DOM elements id and name attributes are separated using a domain specific prefix. This ensures not only separation of portlet domains but also protects against undesirable interaction with (apriori unknown) browser extensions inserting additional objects into the javascript and DOM namespace. Furthermore, the Rewriter can instrument code with dynamic verification of invariants, which could not be statically verified by the Analyzer. For implementation and analysis reasons, the steps performed by the rewriter can also be done after the tagging and before the analysis. In this case, the rewriter would add dynamic verifications for all invariants and the analysis would remove these checks when it can be determined that these invariants hold statically.

In case portlets have a need to communicate, the system libraries can be extended with inter-portlet communication mechanisms, e.g., based on event notification or remote function calls, which perform access control and other mediation steps as well as pass trustworthy context information, e.g., the caller portlet identity, to the callee portlet.

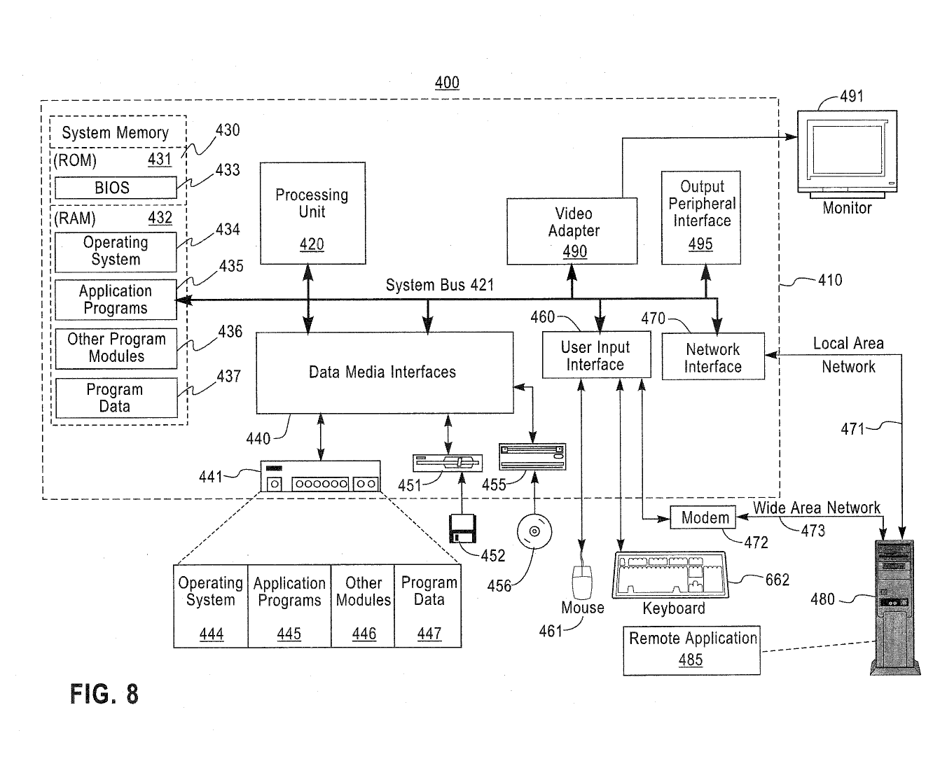

FIG. 8 illustrates an example of a suitable computing system environment 400 on which various exemplary methods may be implemented. Various exemplary devices or systems may include any of the features of the exemplary environment 400. The computing system environment 400 is only one example of a suitable computing environment and is not intended to suggest any limitation as to the scope of use or functionality of the invention. Neither should the computing environment 400 be interpreted as having any dependency or requirement relating to any one or combination of components illustrated in the exemplary operating environment 400.

Various exemplary methods are operational with numerous other general purpose or special purpose computing system environments or configurations. Examples of well known computing systems, environments, and/or configurations that may be suitable for implementation or use include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

Various exemplary methods, applications, etc., may be described in the general context of computer-executable instructions, such as program modules, being executed by a computer. Generally, program modules include routines, programs, objects, components, data structures, etc., that perform particular tasks or implement particular abstract data types. Various exemplary methods may also be practiced in distributed computing environments where tasks are performed by remote processing devices that are linked through a communications network or other communication (e.g., infrared, etc.). In a distributed computing environment, program modules may be located in both local and remote computer storage media including memory storage devices.

With reference to FIG. 8, an exemplary system for implementing the various exemplary methods includes a general purpose-computing device in the form of a computer 410. Components of computer 410 may include, but are not limited to, a processing unit 420, a system memory 430, and a system bus 421 that couples various system components including the system memory 930 to the processing unit 420. The system bus 421 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 410 typically includes a variety of computer readable media. Computer readable media can be any available media that can be accessed by computer 410 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 410. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 430 includes computer storage media in the form of volatile and/or nonvolatile memory such as read only memory (ROM) 431 and random access memory (RAM) 432. A basic input/output system 433 (BIOS), containing the basic routines that help to transfer information between elements within computer 410, such as during start-up, is typically stored in ROM 431. RAM 432 typically contains data and/or program modules that are immediately accessible to and/or presently being operated on by processing unit 420. By way of example, and not limitation, FIG. 8 illustrates operating system 934, application programs 435, other program modules 436, and program data 437.

The computer 410 may also include other removable/non-removable, volatile/nonvolatile computer storage media. By way of example only, FIG. 4 illustrates a hard disk drive 441 that reads from or writes to non-removable, nonvolatile magnetic media, a magnetic disk drive 451 that reads from or writes to a removable, nonvolatile magnetic disk 452, and an optical disk drive 455 that reads from or writes to a removable, nonvolatile optical disk 456 such as a CD ROM or other optical media (e.g., DVD, etc.). Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 441 is typically connected to the system bus 421 through a data media interface such as interface 440, and magnetic disk drive 451 and optical disk drive 455 are typically connected to the system bus 421 a data media interface that is optionally a removable memory interface. For purposes of explanation of the particular example, the magnetic disk drive 451 and the optical disk drive use the data media interface 440.

The drives and their associated computer storage media discussed above and illustrated in FIG. 8, provide storage of computer readable instructions, data structures, program modules and other data for the computer 410. In FIG. 8, for example, hard disk drive 441 is illustrated as storing operating system 444, application programs 445, other program modules 446, and program data 447. Note that these components can either be the same as or different from operating system 434, application programs 435, other program modules 436, and program data 437. Operating system 444, application programs 445, other program modules 446, and program data 447 are given different numbers here to illustrate that, at a minimum, they are different copies. A user may enter commands and information into the computer 410 through input devices such as a keyboard 462 and pointing device 461, commonly referred to as a mouse, trackball or touch pad. Other input devices (not shown) may include a microphone, joystick, game pad, satellite dish, scanner, or the like. These and other input devices are often connected to the processing unit 420 through a user input interface 460 that is coupled to the system bus 421, but may be connected by other interface and bus structures, such as a parallel port, game port or a universal serial bus (USB). A monitor 491 or other type of display device is also connected to the system bus 421 via an interface, such as a video interface 490. In addition to the monitor 491, computers may also include other peripheral output devices such as speakers and printer, which may be connected through an output peripheral interface 495.

The computer 410 may operate in a networked environment using logical connections to one or more remote computers, such as a remote computer 480. The remote computer 480 may be a personal computer, a server, a router, a network PC, a peer device or other common network node, and typically includes many or all of the features described above relative to the computer 410. The logical connections depicted in FIG. 8 include a local area network (LAN) 471 and a wide area network (WAN) 473, but may also include other networks. Such networking environments are commonplace in offices, enterprise-wide computer networks, intranets and the Internet.

When used in a LAN networking environment, the computer 410 is connected to the LAN 471 through a network interface or adapter 470. When used in a WAN networking environment, the computer 410 typically includes a modem 472 or other means for establishing communications over the WAN 473, such as the Internet. The modem 472, which may be internal or external, may be connected to the system bus 421 via the user input interface 460, or other appropriate mechanism. In a networked environment, program modules depicted relative to the computer 410, or portions thereof, may be stored in a remote memory storage device. By way of example, and not limitation, FIG. 8 illustrates remote application programs 485 as residing on the remote computer 480 (e.g., in memory of the remote computer 480). It will be appreciated that the network connections shown are exemplary and other means of establishing a communications link between the computers may be used.

As will be readily apparent to those skilled in the art, the present invention can be realized in hardware, software, or a combination of hardware and software. Any kind of computer/server system(s)—or other apparatus adapted for carrying out the methods described herein—is suited. A typical combination of hardware and software could be a general-purpose computer system with a computer program that, when loaded and executed, carries out the respective methods described herein. Alternatively, a specific use computer, containing specialized hardware for carrying out one or more of the functional tasks of the invention, could be utilized.

The present invention, or aspects of the invention, can also be embodied in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

While it is apparent that the invention herein disclosed is well calculated to fulfill the objects stated above, it will be appreciated that numerous modifications and embodiments may be devised by those skilled in the art, and it is intended that the appended claims cover all such modifications and embodiments as fall within the true spirit and scope of the present invention.

What is claimed is:

1. A method of providing security in a mashup comprised of an agglomeration of a plurality of portlets, wherein said portlets are sent from a portal server and are received by a client browser, the method comprising the steps of:
developing an isolation boundary between the portlets to isolate each of the portlets from each of the other portlets; and
extending said isolation boundary through the portal server and through the client browser.

2. A method according to claim 1, wherein the developing step includes the step of developing said isolation boundary based on a server-side static analysis and code instrumentation of the portlets by the portal server.

3. A method according to claim 1, where a portlet can communicate with another portlet through well-defined and system-mediated communication channels with a portlet in another domain by addition of communications primitives into the system domain.

4. A method according to claim 1, wherein the developing step includes the steps of:
isolating each of the portlets in a respective one security domain, wherein each security domain includes one of the portlets and other domain elements; and
at define times preventing each of the portlets from interacting with any portlet or any other of said domain elements in any security domain other than the security domain in which said each portlet is isolated.

5. A method according to claim 1, wherein the developing step includes the steps of, for each of the portlets:
checking a number of syntactic constraints; and
marking said each of the portlets with a corresponding service domain.

6. A method according to claim 5, wherein the marking step includes the step of wrapping said each of the portlets in a respective one-portlet root.

7. A method according to claim 5, wherein the developing step includes the step of using the portal server to perform the checking and marking steps.

8. A method according to claim 5, wherein the developing step includes the steps of:
aggregating the portlets into a page using a first given language; and
after the aggregating step, converting the page into a second language.

9. A method according to claim 8, wherein the aggregating step includes the step of aggregating the portlets into said page after the checking and marking steps.

10. A method according to claim 9, wherein the developing step includes the step of using the portal server to perform the checking, marking, aggregating and converting steps.

11. A method according to claim 8, wherein the developing step includes the step of, after the converting step, performing a static analysis of isolation and integrity constraints.

12. A method according to claim 11, wherein said constraints include the restriction of DOM tree walking of each portlet to said each portlet's own domain, and the protection of the integrity of system code.

13. A method according to claim 11, wherein the developing step includes the step of using the portal server to perform said static analysis.

14. A method according to claim 1, wherein the developing step includes the step of enabling limited, defined interaction, across said boundary, between selected ones of the portlets.

15. A security system for providing security in a mashup comprised of an agglomeration of a plurality of portlets, wherein said portlets are sent from one or more back-end servers, pass through a portal server, and are received by a client browser, the security system comprising:
a tagger for tagging each of the portlets with a corresponding security domain;
an aggregator for aggregating the portlets into a whole page;
a static analyzer for analyzing the portlets for isolation and integrity constraints; and
a rewriter for rewriting selected code constructs of the portlets.

16. A system according to claim 15, wherein the tagger, the aggregator, the static analyzer and the rewrite are part of the portal server.

17. A system according to claim 16, wherein the tagger, the aggregator, the static analyzer and the rewriter are arranged in sequence in the portal server.

18. A system according to claim 17, wherein the tagger is first in said sequence.

19. A system according to claim 18, wherein, in said sequence, the aggregator is after the tagger, and the static analyzer is after the aggregator.

20. A system according to claim 15, wherein said whole page is in a first language and the aggregator is adapted to convert said whole page into a second language.

21. A system according to claim 16, wherein the portal server develops an isolation boundary for each of the portlets based on the analyzing and on code instrumentation of the portlets.

22. A system according to claim 21, wherein said isolation boundary extends through the portal server and through the client browser.

23. A program storage device readable by machine, tangibly embodying a program of instructions executable by the machine to perform method steps for providing security in a mashup comprised of an agglomeration of a plurality of portlets, wherein said portlets are sent from one or more back-end servers, pass through a portal server, and are received by a client browser, said method steps comprising:
developing an isolation boundary between the portlets to isolate each of the portlets from each of the other portlets; and
extending said isolation boundary through the portal server and through the client browser.

24. A program storage device according to claim 23, wherein said isolation boundary is based on a server-side static analysis and code instrumentation of the portlets by the portal server.

25. A program storage device according to claim 23, wherein the developing step includes the steps of, for each of the portlets:
checking a number of syntactic constraints;
marking said each of the portlets with a corresponding service domain;
aggregating the portlets into a page using a first given language; and
after the aggregating step, converting the page into a second language.

26. A program storage device according to claim 25, wherein the marking step includes the step of wrapping said each of the portlets in a respective one-portlet root.

27. A program storage device according to claim 25, wherein the developing step includes the step of using the portal server to perform the checking, marking, aggregating and converting steps.

28. A method of deploying a computer program product for providing security in a mashup comprised of an agglomeration of a plurality of portlets, wherein said portlets are sent from one or more back-end servers, pass through a portal server, and are received by a client browser, wherein, when executed, the computer program performs the steps of:
developing an isolation boundary between the portlets to isolate each of the portlets from each of the other portlets; and
extending said isolation boundary through the portal server and through the client browser.

29. A method device according to claim 28, wherein said isolation boundary is based on a server-side static analysis and code instrumentation of the portlets by the portal server.

30. A method device according to claim 29, wherein the developing step includes the steps of, for each of the portlets:
checking a number of syntactic constraints;
marking said each of the portlets with a corresponding service domain;
aggregating the portlets into a page using a first given language; and
after the aggregating step, converting the page into a second language.

31. A method device according to claim 30, wherein the marking step includes the step of wrapping said each of the portlets in a respective one-portlet root.

32. A method according to claim 30, wherein the developing step includes the step of using the portal server to perform the checking, marking, aggregating and converting steps.

33. A method of aggregating information services from multiple providers, comprising the steps of:
obtaining portlets from multiple backend servers, each of the back-end servers being associated with one of said multiple providers;
passing the portlets through a portal server and to a browser on a client computer;
rendering said portlets as an integrated page on the client computer; and
developing an isolation boundary between the portlets to isolate each of the portlets from each of the other portlets, including the step of extending said isolation boundary through the portal serger and through the browser.

34. A method according to claim 33, wherein said isolation boundary is based on a serfer-side sttic analyzer and code instrumentation of the portlets by the portal server.

35. A method device according to claim 34, wherein the developing step includes the steps of:
for each of the portlets, checking a number of syntactic constraints, and marking said each of the portlets with a corresponding service domain;
aggregating the portlets into a page using a first given language;
after the aggregating step, converting the page into a second language; and
using the portal server to perform the checking, marking, aggregating and converting steps.
